(19) United States
(12) Patent Application Publication
(10) Pub. No.: US 2026/0180008 A1
(43) Pub. Date: Jun. 25, 2026

(54) SECONDARY BATTERY

(71) Applicant: MURATA MANUFACTURING CO., LTD., Kyoto (JP)

(72) Inventor: Naoki HAYASHI, Kyoto (JP)

(21) Appl. No.: 19/543,359

(22) Filed: Feb. 18, 2026

Related U.S. Application Data
(63) Continuation of application No. PCT/JP2024/026302, filed on Jul. 23, 2024.

(30) Foreign Application Priority Data
Sep. 6, 2023 (JP) 2023-144516

(51) Int. Cl. H01M 10/052; H01M 4/36; H01M 4/38; H01M 4/583; H01M 4/60; H01M 4/62; H01M 10/0566; H01M 50/423; H01M 50/457

(52) U.S. Cl. CPC H01M 10/052; H01M 4/362; H01M 4/386; H01M 4/583; H01M 4/602; H01M 4/622; H01M 10/0566; H01M 50/423; H01M 50/457

(57) ABSTRACT

A secondary battery is provided and includes a positive electrode, a negative electrode, a separator interposed between a main surface of the positive electrode and a main surface of the negative electrode, and an electrolytic solution. The positive electrode includes a positive electrode active material layer. The positive electrode active material layer includes a positive electrode active material and a first polymer compound. The negative electrode includes a negative electrode active material layer. The negative electrode active material layer includes a negative electrode active material and a second polymer compound. The negative electrode active material includes a first negative electrode active material including silicon. The second polymer compound includes an NVA polymer containing N-vinylacetamide as a monomer. The separator includes a base material, a positive-electrode-side coating layer on the positive electrode side of the base material, and a negative-electrode-side coating layer on the negative electrode side of the base material. The positive-electrode-side coating layer includes the first polymer compound. The negative-electrode-side coating layer includes the NVA polymer.

### CROSS REFERENCE TO RELATED APPLICATIONS

The present application is a continuation of International Patent Application No. PCT/JP2024/026302, filed on Jul. 23, 2024, which claims priority to Japanese Patent Application No. 2023-144516, filed on Sep. 6, 2023, the entire contents of which are incorporated herein by reference.

### BACKGROUND

The present disclosure relates to a secondary battery.

A lithium ion battery is disclosed containing, as a binder, a modified polymer including a structure derived from an N-alkyl unsaturated carboxylic acid amide as a monomer unit.

### SUMMARY

The present disclosure relates to a secondary battery.

However, in the secondary battery referenced in the Background section, there is a possibility that cycle characteristics deteriorate due to a decrease in adhesion between a separator and a negative electrode.

The present disclosure has been made in view of the above-described problem, and relates to improve cycle characteristics according to an embodiment.

A secondary battery according to an embodiment of the present disclosure includes a positive electrode, a negative electrode, a separator interposed between a main surface of the positive electrode and a main surface of the negative electrode, and an electrolytic solution, wherein the positive electrode includes a positive electrode active material layer, the positive electrode active material layer contains a positive electrode active material and a first polymer compound, the negative electrode includes a negative electrode active material layer, the negative electrode active material layer contains a negative electrode active material and a second polymer compound, the negative electrode active material contains a first negative electrode active material containing silicon, the second polymer compound contains an NVA polymer containing N-vinylacetamide as a monomer, the separator includes a base material, a positive-electrode-side coating layer on the positive electrode side of the base material, and a negative-electrode-side coating layer on the negative electrode side of the base material, the positive-electrode-side coating layer contains the first polymer compound, and the negative-electrode-side coating layer contains the NVA polymer.

The present disclosure can improve cycle characteristics according to an embodiment.

### BRIEF DESCRIPTION OF THE FIGURES

FIG. 1 is a sectional view illustrating an example of a secondary battery according to an embodiment.

FIG. 2 is an enlarged sectional view illustrating a part of a section of an electrode body according to FIG. 1.

FIG. 3 is a cutaway view illustrating another example of the secondary battery according to an embodiment.

FIG. 4 is a schematic sectional view taken along the line IV-IV in FIG. 3.

### DETAILED DESCRIPTION

Hereinafter, the present disclosure will be described in further detail including with reference to the figures according to an embodiment. The present disclosure is not limited thereby.

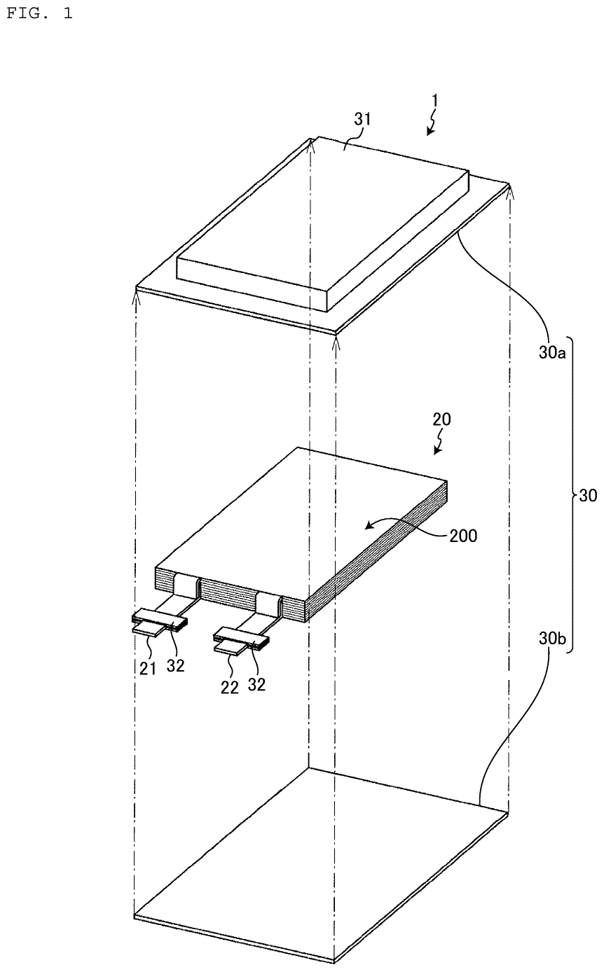

FIG. 1 is a sectional view illustrating an example of a secondary battery according to a first embodiment. A secondary battery 1 illustrated in FIG. 1 is a laminate type lithium ion secondary battery. As illustrated in FIG. 1, the secondary battery 1 includes a battery element 20, an exterior member 30, and a close contact member 32.

The battery element 20 is provided inside the exterior member 30. As illustrated in FIG. 1, the battery element 20 includes an electrode body 200, a positive electrode lead 21, and a negative electrode lead 22. The positive electrode lead 21 is a terminal drawn out from a positive electrode 210 described later to the outside of the exterior member 30. That is, the positive electrode lead 21 is a terminal serving as a plus electrode of the secondary battery 1. In FIG. 1, the positive electrode lead 21 is provided on an end surface of the electrode body 200. The negative electrode lead 22 is a terminal drawn out from the inside of a negative electrode 220 described later to the outside of the exterior member 30. That is, the negative electrode lead 22 is a terminal serving as a minus electrode of the secondary battery 1. In FIG. 1, the negative electrode lead 22 is provided on an end surface of the electrode body 200. Details of the electrode body 200 will be described later.

The exterior member 30 is a case in which the battery element 20 is housed. The exterior member 30 includes two exterior sheets 30a and 30b. The exterior sheets 30a and 30b each include an insulating layer, a metal layer, and an outermost layer. In the example of FIG. 1, a recess 31 is provided in the exterior sheet 30a. With this configuration, the battery element 20 is housed in the recess 31, and the peripheral edges of the exterior sheets 30a and 30b are bonded, whereby the battery element 20 is housed in the exterior member 30.

The exterior sheets 30a and 30b each have a structure in which an insulating layer, a metal layer, and an outermost layer are stacked in this order from the inside, namely, from the side where the battery element 20 is provided, and they are bonded through lamination processing or the like. The insulating layer of each of the exterior sheets 30a and 30b is composed of, for example, a resin such as polyethylene, polypropylene, modified polyethylene, modified polypropylene, or a polyolefin resin containing ethylene or propylene as a monomer. As a result, the exterior sheets 30a and 30b can lower the moisture permeability of the secondary battery 1, and can improve the airtightness. The metal layer of each of the exterior sheets 30a and 30b is a plate material or a foil material of metal such as aluminum, stainless steel, nickel, or iron. The outermost layer may include any material, but is preferably composed of a material having high strength against breakage, piercing, or the like, such as a resin similar to that of the insulating layer, and nylon.

The close contact member 32 is a member for making the exterior member 30 airtight. The close contact member 32 is provided between the exterior member 30 and the positive electrode lead 21 and between the exterior member 30 and the negative electrode lead 22. The material of the close contact member 32 preferably has close contact property to the positive electrode lead 21 and the negative electrode lead 22. For example, when the positive electrode lead 21 and the negative electrode lead 22 are each made of a metal material, a polyolefin resin such as polyethylene, polypropylene, modified polyethylene, or modified polypropylene is used as the close contact member 32. This can make the close contact member 32 to keep the gap between the exterior member 30 and the positive electrode lead 21 and the gap between the exterior member 30 and the negative electrode lead 22 airtight, and thus, the inside of the exterior member 30 can be made airtight.

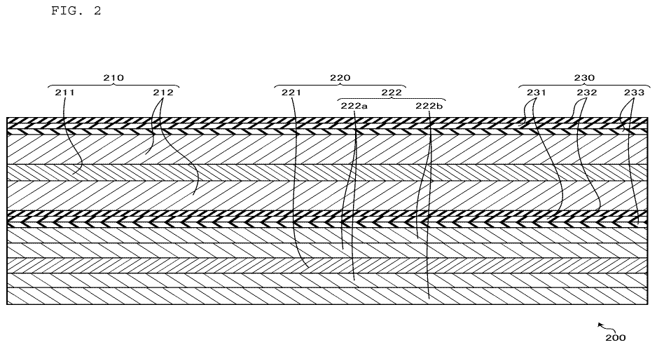

FIG. 2 is an enlarged sectional view illustrating a part of a section of the electrode body according to FIG. 1. More specifically, FIG. 2 is a sectional view illustrating a part of one layer of a positive electrode 210 and one layer of a negative electrode 220 in the electrode body 200. As illustrated in FIG. 2, the electrode body 200 includes the positive electrode 210, the negative electrode 220, and a separator 230. In the secondary battery 1, the electrode body 200 has a structure in which the positive electrode 210 and the negative electrode 220 are stacked in a thickness direction with the separator 230 interposed therebetween. The positive electrode 210 and the negative electrode 220 included in the electrode body 200 are layered members for a charge-discharge reaction of the secondary battery according to the first embodiment.

The positive electrode 210 includes a positive electrode current collector 211 and positive electrode active material layers 212. In the positive electrode 210, the positive electrode current collector 211 is stacked between the positive electrode active material layers 212.

The positive electrode current collector 211 is a conductive layer and, for example, an aluminum foil, a stainless steel foil, or the like can be used. In the example of FIG. 1, the shape of the positive electrode current collector 211 is a rectangular sheet having a protrusion on the positive electrode lead 21 side in plan view in the thickness direction. The protrusion of the positive electrode current collector 211 is connected to the positive electrode lead 21.

The positive electrode active material layer 212 is a layer containing a positive electrode active material. The positive electrode active material layer 212 contains the positive electrode active material, a first polymer compound, and a conductive agent. The positive electrode active material layer 212 is not limited to the materials described above, and it may further contain, for example, a dispersant.

The positive electrode active material is preferably a lithium-containing compound such as a lithium-containing composite oxide or a lithium-containing phosphate compound. The lithium-containing composite oxide is an oxide containing lithium and one or more elements other than lithium as constituent elements. The lithium-containing composite oxide has, for example, a layered rock-salt type or spinel type crystal structure. The lithium-containing phosphate compound is a phosphate compound containing lithium and one or more elements other than lithium as constituent elements. The lithium-containing phosphate compound has, for example, an olivine type crystal structure. Specific examples of the lithium-containing composite oxide include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13})O₂, and LiMn₂O₄. Specific examples of the lithium-containing phosphate compound include LiFePO₄, LiMnPO₄, LiFe_{0.5}Mn_{0.5}PO₄, and LiFe_{0.3}Mn_{0.7}PO₄.

The first polymer compound contained in the positive electrode active material layer 212 is a binder. The first polymer compound may be made of any material, and includes, for example, one or more of synthetic rubber and a polymer compound. Examples of the synthetic rubber include a styrene-butadiene-based rubber, a fluorine-based rubber, and ethylene propylene diene. Examples of the polymer compound include a polyvinylidene fluoride (PVdF) and a polyimide.

The conductive agent contained in the positive electrode active material layer 212 may be made of any material, and includes, for example, carbon. Examples of the carbon include graphite, carbon black, acetylene black, and Ketjen black. The conductive agent contained in the positive electrode active material layer 212 is not limited to these examples as long as the conductive agent is a material with conductivity, and may be a metal material, a conductive polymer, or the like.

The negative electrode 220 includes the negative electrode current collector 221 and negative electrode active material layers 222. In the negative electrode 220, the negative electrode current collector 221 is stacked between the negative electrode active material layers 222.

The negative electrode current collector 221 is a conductor, and for example, a copper foil or the like can be used. In the example of FIG. 1, the shape of the negative electrode current collector 221 is a rectangular sheet having a protrusion on the negative electrode lead 22 side in plan view in the thickness direction. The protrusion of the negative electrode current collector 221 is connected to the negative electrode lead 22.

The negative electrode active material layer 222 is a layer containing a negative electrode active material. The negative electrode active material layer 222 contains a negative electrode active material and a second polymer compound.

The negative electrode active material contains a first negative electrode active material, and preferably further contains a second negative electrode active material. Here, the negative electrode active material refers to a reducing agent in which a reduction reaction occurs in association with charging of the secondary battery 1 and an oxidation reaction occurs in association with discharging of the secondary battery 1, and these oxidation-reduction reactions can reversibly occur. The negative electrode active material refers to a reducing agent capable of performing a reaction of absorbing and desorbing charge carriers of the secondary battery 1.

Thus, for example, fibrous carbon such as carbon nanotubes and carbon fine particles such as carbon black do not substantially absorb or desorb lithium ions which are charge carriers in the lithium ion secondary battery, and thus are not included in the negative electrode active material in the present disclosure.

The first negative electrode active material is a negative electrode active material containing silicon. The negative electrode active material containing silicon contains, for example, simple silicon, an alloy of silicon, and a compound of silicon. Examples of the alloy of silicon that can be used as the first negative electrode active material include one containing at least one selected from the group consisting of tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr) as a second constituent element other than silicon. Examples of the compound of silicon that can be used as the first negative electrode active material include compounds of silicon containing oxygen (O) or carbon (C), such as silicon oxide (SiOₓ) and silicon carbide (SiC), and may contain the above-described second constituent elements in addition to silicon. The first negative electrode active material may be doped with Li. When the first negative electrode active material is SiOₓ, the SiOₓ is preferably pre-doped with Li by doping it with Li in the step of negative electrode production. This makes it possible to reduce the irreversible capacity of SiOₓ as the negative electrode active material. The first negative electrode active material may be a composite of Si and another substance such as carbon, or a composite of a Si alloy and another substance such as carbon. In this case, the irreversible capacity can be reduced. In addition, it is preferable that the particle surface of the first negative electrode active material is partly or fully covered with carbon. This can improve the electron conductivity of the particle surface of the first negative electrode active material.

The second negative electrode active material is a negative electrode active material containing carbon as a constituent element. Examples of the material that can be used as the second negative electrode active material include mesocarbon microbeads (MCMB), artificial graphite, natural graphite, non-graphitizable carbon, and graphitizable carbon. More specifically, the material that can be used as the second negative electrode active material includes pyrolytic carbons, cokes, glassy carbon fibers, organic polymer compound fired bodies, activated carbon, and carbon blacks. Examples of the cokes include pitch coke, needle coke, and petroleum coke. The organic polymer compound fired body is a substance obtained by firing a polymer compound such as a phenol resin or a furan resin at an appropriate temperature to carbonize it.

The negative electrode active material is not limited to the first negative electrode active material and the second negative electrode active material, and may contain other negative electrode active materials, for example, a material capable of occluding and releasing lithium, such as an alloy or compound of a metal or metalloid, or an alloy or compound of tin (Sn). Examples of the metal and the metalloid that can be used as the negative electrode active material include tin (Sn), lead (Pb), aluminum (Al), indium (In), zinc (Zn), antimony (Sb), bismuth (Bi), cadmium (Cd), magnesium (Mg), boron (B), gallium (Ga), germanium (Ge), arsenic (As), silver (Ag), zirconium (Zr), yttrium (Y), and hafnium (Hf). Among these, germanium, tin, and lead are preferable. Tin is more preferable because tin has a great ability to occlude and release lithium, and a high energy density can be attained.

Here, the first negative electrode active material is preferably contained in an amount of 30 mass % or more in the negative electrode active material. That is, the mass fraction of the first negative electrode active material to the negative electrode active material is preferably 30% or more. This can improve the negative electrode capacity. The mass fraction of the first negative electrode active material with respect to the negative electrode active material can be calculated by discriminating between particles containing silicon (Si) and particles containing only carbon (C) in an EDX (energy dispersive X-ray spectroscopy) mapping image of a cut surface along the thickness direction of the negative electrode active material layer 222. More specifically, the particle size distribution of each of particles containing Si (particles of the first negative electrode active material) and particles containing only C (particles of the second negative electrode active material) is acquired using image analysis software such as Image J. The volume distribution is obtained from the obtained particle size distribution, and the volume of each particle is summed to calculate the sum of the volumes of the particles containing Si and the sum of the volumes of the particles containing only C. Since the density of the particles containing Si and the density of the particles containing only C can be approximated to be the same, the mass fraction of the first negative electrode active material can be calculated by using the following Calculation Formula (1).

(Mass fraction (%) of first negative electrode active material)=(sum of volumes of particles containing Si)/[(sum of volumes of particles containing Si)+(sum of volumes of particles containing only C)] (1)

Here, when the region where the particle size distribution is acquired is too narrow, the error increases, and thus the particle size distribution is acquired in the region where the maximum width is 100 μm or more. The particle size distribution is acquired by determining the particle size distribution with image analysis software based on the particle sizes of a plurality of particles measured with the image analysis software such as Image J.

Examples of the alloy of tin that can be used as the negative electrode active material include alloys including at least one from the group consisting of nickel, copper, iron, cobalt, manganese, zinc, indium, silver, titanium, germanium, bismuth, antimony, and chromium as the second constituent element other than tin. Examples of the compound of tin that can be used as the negative electrode active material include those including oxygen or carbon, and the compound of tin may include the above-described second constituent elements in addition to tin.

The second polymer compound contained in the negative electrode active material layer 222 is a binder containing a polymer (NVA polymer) containing N-vinylacetamide (NVA) as a monomer. The NVA polymer that can be used as the second polymer compound includes poly-N-vinylacetamide (PNVA) and a copolymer containing NVA as monomers. The copolymer containing NVA as a monomer, which can be used as the second polymer compound, further contains at least one of alkali metal acrylate, alkali metal methacrylate, and derivatives of alkali metal acrylate and alkali metal methacrylate as monomers. Here, the alkali metal salt refers to a salt containing an alkali metal such as lithium (Li), sodium (Na), or potassium (K). This can suppress a decrease in the electron conductivity between the negative electrode active material particles due to the expansion and contraction of the negative electrode active material layer 222 in association with the charge-discharge cycle, and thus, the cycle retention rate can be improved.

The mass fraction of the NVA polymer in the negative electrode active material layer 222 on the separator 230 side is larger than that in the negative electrode active material layer 222 on the negative electrode current collector 221 side. Specifically, for example, a portion of the negative electrode active material layer 222 in contact with the separator 230 has a larger mass fraction of the NVA polymer than a portion of the negative electrode active material layer 222 in contact with the negative electrode current collector 221. In the first embodiment, the negative electrode active material layer 222 has a first layer 222a on the negative electrode current collector 221 side and a second layer 222b on the separator 230 side. The mass fraction of the NVA polymer in the second layer 222b is larger than that in the first layer 222a. This further improves adhesion between the separator 230 and the negative electrode 220, and thus, cycle characteristics can be further improved. The method for varying the mass fraction of the NVA polymer is not limited to the above. For example, the mass fraction of the NVA polymer in the negative electrode active material layer 222 on the separator 230 side may be made larger than that in the negative electrode active material layer 222 on the negative electrode current collector 221 side by changing the production conditions of the negative electrode active material layer 222 such as the drying rate of the negative electrode mixture slurry. The distribution of the mass fraction of the NVA polymer in the negative electrode active material layer 222 in the thickness direction can be measured by quantifying N (nitrogen) contained in the NVA polymer in the EDX mapping image of the section cut along the thickness direction of the negative electrode active material layer 222. The negative electrode active material layer 222 is divided into half regions in the thickness direction, and the mass concentration of N contained in the first layer 222a on the negative electrode current collector 221 side and the mass concentration of N contained in the second layer 222b on the separator 230 side are measured. Based on the measured mass concentration of N, the difference in the mass concentration of N between the first layer 222a and the second layer 222b is calculated using the following Calculation Formula (2). When the difference in the mass concentration of N is 10% or more, it can be said that the mass fraction of the NVA polymer in the negative electrode active material layer 222 on the separator 230 side is larger than that in the negative electrode active material layer 222 on the negative electrode current collector 221 side.

(Difference in mass concentration of N between first layer 222a and second layer 222b) (%)=[(mass % of N contained in second layer 222b)−(mass % of N contained in first layer 222a)]/[(mass % of N contained in second layer 222b)+(mass % of N contained in first layer 222a)]×100 (2)

The negative electrode active material layer 222 is not limited to containing only the negative electrode active material and the second polymer compound, and may further contain, for example, a negative electrode conductive agent. The negative electrode conductive agent contains at least one of a carbon material, a metal material, and a conductive polymer compound. Specific examples of the carbon material for use as the negative electrode conductive agent include particulate carbon materials such as carbon black, acetylene black, and Ketjen black, and fibrous carbon materials such as carbon nanotubes. The carbon nanotube is, for example, a single wall carbon nanotube (SWCNT). This can improve the electron conductivity of the particle surface of the first negative electrode active material. The mass fraction of the negative electrode conductive agent to the negative electrode active material layer 222 is preferably 5% or less, more preferably 2% or less. This can improve the coating properties of a negative electrode slurry.

The separator 230 is a film that insulates the positive electrode 210 from the negative electrode 220. The separator 230 is provided between a main surface of the positive electrode 210 and a main surface of the negative electrode 220 to keep the positive electrode 210 and the negative electrode 220 from coming into direct contact with each other. In the example of FIG. 1, the shape of the separator 230 is a rectangular sheet in plan view in the thickness direction. The separator 230 includes a base material 231, a positive-electrode-side coating layer 232, and a negative-electrode-side coating layer 233.

Preferably, the material of the base material 231 is electrically stable, is chemically stable against the positive electrode active material, the negative electrode active material, and the electrolytic solution, and has an insulating property. As the base material 231, for example, a layer composed of a polymer nonwoven fabric, a porous film, or a fiber of glass or ceramics can be used. The material of the base material 231 more preferably includes a porous polyolefin film. This can improve the safety of the battery because of the short circuit preventing effect and the shutdown effect.

The positive-electrode-side coating layer 232 is a layer that covers the positive electrode 210 side of the base material 231. The positive-electrode-side coating layer 232 contains the first polymer compound. This improves adhesion between the separator 230 and the positive electrode 210, and thus, cycle characteristics can be improved.

The negative-electrode-side coating layer 233 is a layer that covers the negative electrode 220 side of the base material 231. The negative-electrode-side coating layer 233 contains an NVA polymer. This improves adhesion between the separator 230 and the negative electrode 220, and thus, cycle characteristics can be improved.

The positive-electrode-side coating layer 232 and the negative-electrode-side coating layer 233 preferably further contain particles composed of an inorganic substance. Examples of the inorganic substance include metal, semiconductor, oxides of metal and semiconductor, and nitrides of metal and semiconductor. Examples of the metal to be used as the inorganic substance include aluminum (Al) and titanium (Ti). Examples of the semiconductor to be used as the inorganic substance include silicon (Si) and boron (B). Examples of the oxides and the nitrides to be used as the inorganic substance include alumina (Al₂O₃), boron nitride (BN), aluminum nitride (AlN), titanium dioxide (TiO₂), and silicon dioxide (SiO₂). In addition, the inorganic substance preferably is one having insulating properties, having good availability, and having a large heat capacity. The particle diameter of the particles of the inorganic substance is not particularly limited, and for example, when alumina is used as the inorganic substance, particles having an average particle diameter of 0.5 μm can be used.

The separator 230 is impregnated with the electrolytic solution. In the example of FIG. 1, the electrolytic solution is filled into a space in the exterior member 30. The electrolytic solution is a non-aqueous electrolytic solution containing an electrolyte salt and a solvent that dissolves the electrolyte salt.

Examples of the electrolyte salt include lithium salts such as lithium perchlorate (LiClO₄), lithium hexafluorophosphate (LiPF₆), lithium tetrafluoroborate (LiBF₄), lithium bis(trifluoromethanesulfonyl)imide (LiN(SO₂CF₃)₂), lithium bis(pentafluoroethanesulfonyl)imide (LiN(SO₂C₂F₅)₂), and lithium hexafluoroarsenate (LiAsF₆).

Examples of the solvent include non-aqueous solvents including lactone-based solvents such as γ-butyrolactone, γ-valerolactone, δ-valerolactone, and ε-caprolactone, carbonate ester-based solvents such as ethylene carbonate, propylene carbonate, butylene carbonate, vinylene carbonate, dimethyl carbonate, ethyl methyl carbonate, and diethyl carbonate, ether-based solvents such as 1,2-dimethoxyethane, 1-ethoxy-2-methoxyethane, 1,2-diethoxyethane, tetrahydrofuran, and 2-methyltetrahydrofuran, nitrile-based solvents such as acetonitrile, sulfolane-based solvents, phosphoric acids, phosphoric acid ester solvents, and pyrrolidones.

The electrolytic solution preferably contains at least one of a fluorinated carboxylic acid ester, a sulfonic acid ester, a sulfonic acid anhydride, and a carboxylic acid anhydride as an additive. This promotes generation of a solid electrolyte interphase (SEI) having a small resistance, and thus, charge load characteristics can be improved. Examples of the fluorinated carboxylic acid ester include fluoroethylene carbonate (FEC). Examples of the sulfonic acid anhydride include propanedisulfonic acid anhydride (PSAH). Examples of the sulfonic acid ester include 1,3-propane sultone. Examples of the carboxylic acid anhydride include 1,4-dioxane-2,6-dione.

Although the battery according to the first embodiment has been described above, the secondary battery according to the first embodiment is not limited to the example illustrated in FIG. 1. Hereinafter, other examples will be described with reference to drawings, but configurations similar to those in FIGS. 1 and 2 are denoted by reference symbols, and description thereof will be omitted.

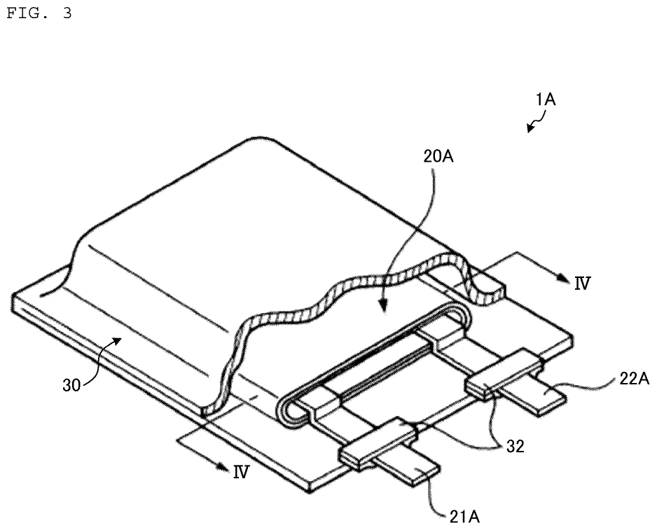

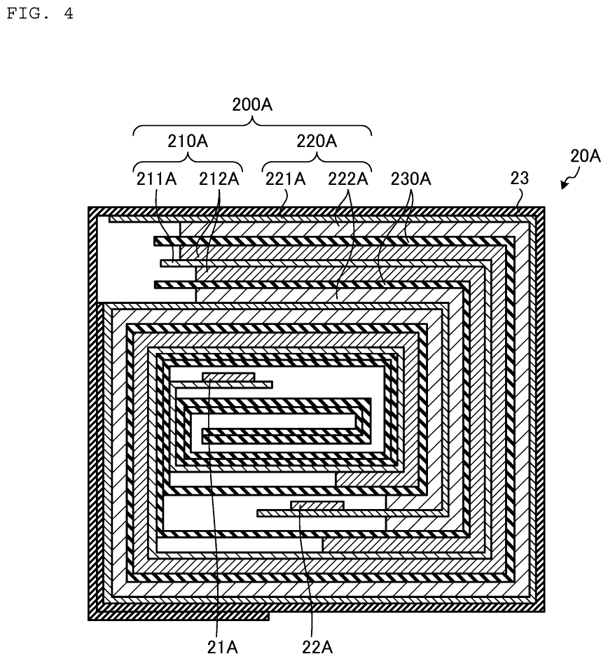

FIG. 3 is a cutaway view illustrating another example of the secondary battery according to the first embodiment. FIG. 4 is a schematic sectional view taken along the line IV-IV in FIG. 3. A secondary battery 1A illustrated in FIGS. 3 and 4 is different from the example according to FIG. 1 in that the electrode body 200 has a structure in which the electrode body 200 is wound with a positive electrode lead 21A and a negative electrode lead 22A positioned at the center.

The battery element 20A is provided inside the exterior member 30. As illustrated in FIG. 4, the battery element 20A includes an electrode body 200A, the positive electrode lead 21A, the negative electrode lead 22A, and a protective material 23. The positive electrode lead 21A is a terminal drawn out from the inside of the battery element 20A to the outside of the exterior member 30, and the positive electrode lead 21A is provided near the center of the battery element 20A. The negative electrode lead 22A is a terminal drawn out from the inside of the battery element 20A to the outside of the exterior member 30, and the negative electrode lead 22A is provided near the center of the battery element 20A. The protective material 23 is a member that protects the exterior of the battery element 20A. The protective material 23 is provided to be wound around the electrode body 200A. The protective material 23 is, for example, an insulator tape.

In the example of FIG. 4, the electrode body 200A is a stack for a charge-discharge reaction of the secondary battery according to the first embodiment. The electrode body 200A includes: a positive electrode 210A including a positive electrode current collector 211A and a positive electrode active material layer 212A; a negative electrode 220A including a negative electrode current collector 221A and a negative electrode active material layer 222A; and a separator 230A. The electrode body 200A has a structure in which the electrode body 200A is wound with the positive electrode lead 21A and the negative electrode lead 22A positioned at the center, and the negative electrode current collector 221A, the negative electrode active material layer 222A, the separator 230A, the positive electrode active material layer 212A, the positive electrode current collector 211A, the positive electrode active material layer 212A, the separator 230A, and the negative electrode active material layer 222A are stacked in this order from the outside, namely, from the protective material 23 side. In the electrode body 200A, no layer other than the negative electrode current collector 221A, the separator 230A, or the positive electrode current collector 211A is provided in the vicinity of the positive electrode lead 21A and the negative electrode lead 22A. With this structure, the positive electrode current collector 211A is connected to the positive electrode lead 21A, and the negative electrode current collector 221A is connected to the negative electrode lead 22A.

As described above, the secondary battery 1 according to the first embodiment includes the positive electrode 210, the negative electrode 220, the separator 230 interposed between the positive electrode 210 and the negative electrode 220, and an electrolytic solution. The positive electrode 210 has the positive electrode active material layer 212. The positive electrode active material layer 212 contains a positive electrode active material and a first polymer compound. The negative electrode 220 has the negative electrode active material layer 222. The negative electrode active material layer 222 contains a negative electrode active material and a second polymer compound. The negative electrode active material contains a first negative electrode active material containing silicon. The second polymer compound contains an NVA polymer containing N-vinylacetamide as a monomer. The separator 230 includes the base material 231, the positive-electrode-side coating layer 232 on the positive electrode 210 side of the base material 231, and the negative-electrode-side coating layer 233 on the negative electrode 220 side of the base material 231. The positive-electrode-side coating layer 232 contains the first polymer compound. The negative-electrode-side coating layer 233 contains an NVA polymer.

This can maintain the binding between the separator 230 and the electrode in the charge-discharge cycle and can suppress the decrease in the electron conductivity between the negative electrode active material particles due to the expansion and contraction of the negative electrode active material layer 222 in association with the charge-discharge cycle. Thus, it is possible to improve the cycle characteristics.

As a desirable aspect, the mass fraction of the NVA polymer in the negative electrode active material layer 222 on the separator 230 side is larger than that in the negative electrode active material layer 222 on the side opposite to the separator 230. This can maintain the binding between the separator 230 and the negative electrode 220 and can further improve the cycle characteristics.

As a desirable aspect, the negative electrode active material further contains a second negative electrode active material containing carbon, and the mass fraction of the first negative electrode active material to the negative electrode active material is 30% or more. This can further improve the cycle characteristics.

### EXAMPLES

Hereinafter, Examples will be described according to an embodiment. Table 1 is a table showing Examples and Comparative Examples. The present disclosure is not limited by the present Examples.

TABLE 1

| | Negative electrode | | | First layer | | | | Second layer | |
|---|---|---|---|---|---|---|---|---|---|
| | active material layer | | | First | Second | | | First | Second |
| | First | Second | | negative | negative | | | negative | negative |
| | negative | negative | | electrode | electrode | | | electrode | electrode |
| | electrode | electrode | Negative | active | active | Negative | Mass | active | active |
| | active | active | electrode | material | material | electrode | fraction | material | material |
| | material | material | binder | A1 (mass %) | B1 (mass %) | binder (mass %) | w1 (%) | A2 (mass %) | B2 (mass %) |
| Example 1 | SiOₓ | MCMB | PNVA | 47.5 | 47.5 | 4 | 50 | 46.5 | 46.5 |
| Example 2 | SiOₓ | MCMB | NVA-AANa | 47.5 | 47.5 | 4 | 50 | 46.5 | 46.5 |
| Example 3 | SiOₓ | MCMB | NVA-AALi | 47.5 | 47.5 | 4 | 50 | 46.5 | 46.5 |
| Example 4 | SiOₓ | MCMB | NVA-AAK | 47.5 | 47.5 | 4 | 50 | 46.5 | 46.5 |
| Example 5 | SiOₓ | MCMB | PNVA | 47 | 47 | 5 | 50 | 47 | 47 |
| Example 6 | SiOₓ | MCMB | PNVA | 9.5 | 85.5 | 4 | 10 | 9.3 | 83.7 |
| Example 7 | SiOₓ | MCMB | PNVA | 28.5 | 66.5 | 4 | 30 | 27.9 | 65.1 |
| Example 8 | SiOₓ | MCMB | PNVA | 66.5 | 28.5 | 4 | 70 | 65.1 | 27.9 |
| Example 9 | SiOₓ | MCMB | PNVA | 91.8 | 0 | 7.2 | 100 | 88.2 | 0 |
| Example 10 | Si | MCMB | PNVA | 91.8 | 0 | 7.2 | 100 | 88.2 | 0 |
| Example 11 | SiTi_{0.01} | MCMB | PNVA | 91.8 | 0 | 7.2 | 100 | 88.2 | 0 |
| Comparative | SiOₓ | MCMB | PNVA | 47.5 | 47.5 | 4 | 50 | 46.5 | 46.5 |
| Example 1 | | | | | | | | | |
| Comparative | SiOₓ | MCMB | PNVA | 47.5 | 47.5 | 4 | 50 | 46.5 | 46.5 |
| Example 2 | | | | | | | | | |
| Comparative | SiOₓ | MCMB | PAA | 47.5 | 47.5 | 4 | 50 | 46.5 | 46.5 |
| Example 3 | | | | | | | | | |
| Comparative | SiOₓ | MCMB | PAA | 47.5 | 47.5 | 4 | 50 | 46.5 | 46.5 |
| Example 4 | | | | | | | | | |

| | | | Positive | | | Charge-discharge | |
|---|---|---|---|---|---|---|---|
| | Second layer | | electrode active | Separator | | measurement | |
| | Negative | Mass | material layer | Second | First | Cycle | Negative |
| | electrode | fraction | Positive | polymer | polymer | retention | electrode |
| | binder (mass %) | w2 (%) | electrode binder | compound | compound | rate (%) | capacity (%) |
| Example 1 | 6 | 50 | PVdF | PNVA | PVdF | 95 | 188 |
| Example 2 | 6 | 50 | PVdF | NVA-AANa | PVdF | 94 | 185 |
| Example 3 | 6 | 50 | PVdF | NVA-AALi | PVdF | 93 | 186 |
| Example 4 | 6 | 50 | PVdF | NVA-AAK | PVdF | 93 | 184 |
| Example 5 | 5 | 50 | PVdF | PNVA | PVdF | 90 | 189 |
| Example 6 | 6 | 10 | PVdF | PNVA | PVdF | 97 | 100 |
| Example 7 | 6 | 30 | PVdF | PNVA | PVdF | 97 | 144 |
| Example 8 | 6 | 70 | PVdF | PNVA | PVdF | 93 | 237 |
| Example 9 | 10.8 | 100 | PVdF | PNVA | PVdF | 90 | 272 |
| Example 10 | 10.8 | 100 | PVdF | PNVA | PVdF | 83 | 707 |
| Example 11 | 10.8 | 100 | PVdF | PNVA | PVdF | 88 | 270 |
| Comparative | 6 | 50 | PVdF | PNVA | PNVA | 72 | 188 |
| Example 1 | | | | | | | |
| Comparative | 6 | 50 | PVdF | PVdF | PVdF | 70 | 188 |
| Example 2 | | | | | | | |
| Comparative | 6 | 50 | PVdF | PNVA | PVdF | 64 | 187 |
| Example 3 | | | | | | | |
| Comparative | 6 | 50 | PVdF | PAA | PVdF | 62 | 186 |
| Example 4 | | | | | | | |

### Example 1

The positive electrode according to Example 1 was produced by the following method. A positive electrode mixture slurry was obtained by mixing 95 mass % of lithium cobalt oxide (LiCoO₂) as a positive electrode active material, 2 mass % of amorphous carbon powder (Ketjen black) as a conductive agent, and 3 mass % of PVdF as a first polymer compound and dispersing the mixture in N-methyl-2-pyrrolidone (NMP). The produced positive electrode mixture slurry was uniformly applied to both surfaces of a strip-shaped aluminum foil having a thickness of 10 μm as a positive electrode current collector, whereby a positive electrode coated body was produced. The obtained positive electrode coated body was dried with hot air and then compression-molded with a roll press machine, whereby a positive electrode sheet was formed. The positive electrode sheet formed through the above steps was cut into a strip shape of 70 mm×800 mm, whereby the positive electrode according to Example 1 was produced. A positive electrode lead was attached to the produced positive electrode at a part where the positive electrode current collector was exposed.

The negative electrode according to Example 1 was produced by the following method. A first layer of negative electrode mixture slurry was obtained by charging 47.5 mass % of Li-pre-doped SiOₓ as the first negative electrode active material, 47.5 mass % of MCMB as the second negative electrode active material, 4 mass % of PNVA as the second polymer compound, and 0.7 mass % of carbon black and 0.3 mass % of SWCNT as the negative electrode conductive agent into an appropriate amount of ion-exchanged water, and the mixture was kneaded and stirred with a planetary centrifugal mixer. Similarly, a second layer of negative electrode mixture slurry was obtained by charging 46.5 mass % of Li-pre-doped SiOₓ as the first negative electrode active material, 46.5 mass % of MCMB as the second negative electrode active material, 6 mass % of PNVA as the second polymer compound, and 0.7 mass % of carbon black and 0.3 mass % of SWCNT as the negative electrode conductive agent into an appropriate amount of ion-exchanged water, and the mixture was kneaded and stirred with a planetary centrifugal mixer. The negative electrode mixture slurry of the first layer and the negative electrode mixture slurry of the second layer were uniformly and continuously applied so as to be stacked in this order on both surfaces of a copper foil having a thickness of 8 μm as a negative electrode current collector, whereby a negative electrode coated body was formed. The obtained negative electrode coated body was dried with hot air and then compression-molded with a roll press machine, whereby a negative electrode sheet was formed. The negative electrode sheet was cut into a strip shape of 72 mm×810 mm, whereby a negative electrode according to Example 1 was produced. A negative electrode lead was attached to the produced negative electrode at a part where the negative electrode current collector was exposed.

In the following description, it is assumed that the first negative electrode active material is A1 mass %, and the second negative electrode active material is B1 mass % in the first layer. In this case, the mass fraction w1(%) of the first negative electrode active material to the negative electrode active material in the first layer has a relationship of the following Formula (3). It is assumed that, in the second layer, the first negative electrode active material is A2 mass %, and the second negative electrode active material is B2 mass %. In this case, the mass fraction w2(%) of the first negative electrode active material to the negative electrode active material in the second layer has a relationship of the following Formula (4).

$$\begin{matrix}w 1 = A 1 / ( A 1 + B 1 ) \times 100 & ( 3 ) \\ w 2 = A 2 / ( A 2 + B 2 ) \times 100 & ( 4 )\end{matrix}$$

In Example 1, in the first layer and the second layer, the first negative electrode active material is a silicon compound (SiOₓ), and the second negative electrode active material is MCMB. As shown in Table 1, the mass fraction w1 of Example 1 is 50% (=47.5 mass %/(47.5 mass %+47.5 mass %)). The mass fraction w2 of Example 1 is 50% (=46.5 mass %/(46.5 mass %+46.5 mass %)).

The separator according to Example 1 was produced by the following method. To a solution in which PVdF having an average molecular weight of 150,000 as a binder and NMP as a solvent were mixed at a mass ratio of 10:90 and sufficiently dissolved, alumina (Al₂O₃) fine powder having an average particle diameter of 0.5 μm as particles composed of an inorganic substance was added so as to be twice the mass of PVdF, and sufficiently stirred, whereby a coating slurry for a positive-electrode-side sheet layer was produced. To a solution produced by mixing PNVA having an average molecular weight of 1,000,000 as a binder and ion-exchanged water as a solvent at a mass ratio of 3:97, alumina (Al₂O₃) fine powder having an average particle diameter of 0.5 μm as an inorganic substance was added so as to be twice the mass of the PNVA, and the mixture was sufficiently stirred, whereby a coating slurry for a negative-electrode-side sheet layer was produced. The produced coating slurry for the positive-electrode-side sheet layer and the produced coating slurry for the negative-electrode-side sheet layer were applied to respective surfaces of a microporous polyethylene film having a thickness of 15 μm as a base material to form the positive-electrode-side sheet layer and the negative-electrode-side sheet layer so as to have a thickness of 3 μm, whereby a separator sheet was produced. The separator sheet was cut into a strip shape of 74 mm×860 mm, whereby the separator according to Example 1 was produced.

The electrolytic solution according to Example 1 was produced by dissolving lithium hexafluorophosphate (LiPF₆) as an electrolyte salt in a solvent obtained by mixing ethylene carbonate (EC) and ethyl methyl carbonate (EMC) at a mass ratio of 5:5 so as to have a molar concentration of 1 mol/L.

The secondary battery according to Example 1 was produced by the following method. An electrode body was produced by stacking the positive electrode and the negative electrode with the produced separator interposed therebetween, bringing them into close contact with each other, and winding them in a longitudinal direction, and attaching a protective tape as a protective material to the outermost peripheral portion of the wound stack. The produced electrode body was placed in an exterior member, and three sides of the exterior member were thermally fused, such that the other one side was provided with an opening without being thermally fused. For the exterior member, a laminate film was used, which was a laminate of a 25 μm thick nylon film as an outermost layer, a 40 μm thick aluminum foil as a metal layer, and a 30 μm thick polypropylene film as an insulating layer. Thereafter, the electrolytic solution produced as described above was injected from the opening of the exterior member, and the remaining one side of the exterior member was thermally fused in a reduced pressure environment to seal the exterior member, whereby the secondary battery according to Example 1 was produced.

In Example 1, the negative electrode capacity was calculated by the following method. Here, the negative electrode capacity refers to the capacity of the negative electrode active material.

A counter electrode Li coin cell was separately produced with a positive electrode in which the positive electrode active material layer according to Example 1 was formed only on one surface of a positive electrode current collector, and charging was performed under the following conditions to measure the electric capacity, and the charge capacity per thickness of the positive electrode active material layer was determined.
Charge rate: 0.1 C
Charge method: CCCV
Charge control voltage: 4.45 V
Charge termination current: 0.01 C

Similarly, a counter electrode Li coin cell was produced with a negative electrode in which the negative electrode active material layer according to Example 1 was formed only on one side of the negative electrode current collector with the components according to Example 1, and charging was performed under the following conditions to measure the electric capacity, whereby the charge capacity per thickness of the negative electrode active material was obtained.
Charge rate: 0.1 C
Charge method: CCCV
Charge control voltage: 0 V
Charge termination current: 0.01 C

Using the charge capacity per thickness of the positive electrode active material and the charge capacity per thickness of the negative electrode active material measured as described above, the thicknesses of the positive electrode active material layer and the negative electrode active material layer were adjusted by changing the solid content ratio, coating speed, and the like of the positive electrode mixture slurry and the negative electrode mixture slurry so that the charge capacity of the positive electrode with respect to the charge capacity of the negative electrode was 0.9, whereby a battery for measurement was produced. The produced battery for measurement was discharged under the following conditions to measure the capacity, and the negative electrode capacity was calculated. Here, the negative electrode capacity was calculated as a relative value with respect to a value in Example 6 described later.
Discharge rate: 0.1 C
Discharge method: CC
Discharge termination voltage: 1.0 V

In Example 1, a cycle characteristic test was performed by the following method. The cycle characteristics test was performed at 23° C.

The battery produced as described above was charged and discharged in the first cycle under the following conditions.
Charge rate: 0.2 C
Charge method: CCCV
Charge control voltage: 4.40 V
Charge termination current: 0.025 C
Discharge rate: 0.1 C
Discharge method: CC
Discharge termination voltage: 3.0V

Thereafter, the 2nd cycle to the 100th cycle were performed under the following conditions. The discharge capacity at the 2nd cycle and the discharge capacity at the 100th cycle were measured, and the ratio of the discharge capacity at the 100th cycle to the discharge capacity at the 2nd cycle was calculated as a cycle retention rate.
Charge rate: 1.0 C
Charge method: CCCV
Charge control voltage: 4.40 V
Charge termination current: 0.025 C
Discharge rate: 1.0 C
Discharge method: CC
Discharge termination voltage: 3.0V

### Example 2

In Example 2, a battery was produced in the same manner as in Example 1 except that the second polymer compound and the binder of the negative electrode side coating layer were changed to a copolymer of NVA and sodium acrylate (NVA-AANa) as shown in Table 1, and the measurement was performed.

### Example 3

In Example 3, a battery was produced in the same manner as in Example 1 except that the second polymer compound and the binder of the negative electrode side coating layer were changed to a copolymer of NVA and lithium acrylate (NVA-AALi) as shown in Table 1, and the measurement was performed.

### Example 4

In Example 4, a battery was produced in the same manner as in Example 1 except that the second polymer compound and the binder of the negative electrode side coating layer were changed to a copolymer of NVA and potassium acrylate (NVA-AAK) as shown in Table 1, and the measurement was performed.

### Example 5

In Example 5, as shown in Table 1, a battery was produced in the same manner as in Example 1 except that the mass fractions of the second polymer compound in each of the first layer and the second layer were each 5%, and the measurement was performed.

### Example 6

In Example 6, as shown in Table 1, a battery was produced in the same manner as in Example 1 except that the mass fraction w1 of the first negative electrode active material to the negative electrode active material in the first layer was changed to 10% (=9.5 mass %/(9.5 mass %+85.5 mass %)), and the mass fraction w2 of the second negative electrode active material to the negative electrode active material in the second layer was changed to 10% (=9.3 mass %/(9.3 mass %+83.7 mass %)), and the measurement was performed.

### Example 7

In Example 7, as shown in Table 1, a battery was produced in the same manner as in Example 1 except that the mass fraction w1 of the first negative electrode active material to the negative electrode active material in the first layer was changed to 30% (=28.5 mass %/(28.5 mass %+66.5 mass %)), and the mass fraction w2 of the second negative electrode active material to the negative electrode active material in the second layer was changed to 30% (=27.9 mass %/(27.9 mass %+65.1 mass %)), and the measurement was performed.

### Example 8

In Example 8, as shown in Table 1, a battery was produced in the same manner as in Example 1 except that the mass fraction w1 of the first negative electrode active material to the negative electrode active material in the first layer was changed to 70% (=66.5 mass %/(66.5 mass %+28.5 mass %)), and the mass fraction w2 of the second negative electrode active material to the negative electrode active material in the second layer was changed to 70% (=65.1 mass %/(65.1 mass %+27.9 mass %)), and the measurement was performed.

### Example 9

In Example 9, as shown in Table 1, a battery was produced in the same manner as in Example 1 except that the mass fraction w1 of the first negative electrode active material to the negative electrode active material in the first layer was changed to 100% (=91.8 mass %/(91.8 mass %+0 mass %)), and the mass fraction w2 of the second negative electrode active material to the negative electrode active material in the second layer was changed to 100% (=88.2 mass %/(88.2 mass %+0 mass %)), and the measurement was performed.

### Example 10

In Example 10, as shown in Table 1, a battery was produced in the same manner as in Example 9 except that the first negative electrode active materials of the first layer and the second layer were changed to simple silicon (Si), the mass fraction w1 of the first negative electrode active material to the negative electrode active material in the first layer was changed to 100% (=91.8 mass %/(91.8 mass %+0 mass %)), and the mass fraction w2 of the second negative electrode active material to the negative electrode active material in the second layer was changed to 100% (=88.2 mass %/(88.2 mass %+0 mass %)), and the measurement was performed.

### Example 11

In Example 11, as shown in Table 1, a battery was produced in the same manner as in Example 9 except that the first negative electrode active materials of the first layer and the second layer were changed to a silicon-containing alloy (SiTi_{0.01}), the mass fraction w1 of the first negative electrode active material to the negative electrode active material in the first layer was changed to 100% (=91.8 mass %/(91.8 mass %+0 mass %)), and the mass fraction w2 of the second negative electrode active material to the negative electrode active material in the second layer was changed to 100% (=88.2 mass %/(88.2 mass %+0 mass %)), and the measurement was performed.

### Comparative Example 1

In Comparative Example 1, a battery was produced in the same manner as in Example 1 except that the binder of the positive-electrode-side coating layer of the separator was changed to PNVA as shown in Table 1, and the measurement was performed.

### Comparative Example 2

In Comparative Example 2, a battery was produced in the same manner as in Example 1 except that the binder of the negative-electrode-side coating layer of the separator was changed to PVdF as shown in Table 1, and the measurement was performed.

### Comparative Example 3

In Comparative Example 3, a battery was produced in the same manner as in Example 1 except that the second polymer compound was changed to polyacrylic acid (PAA) as shown in Table 1, and the measurement was performed.

### Comparative Example 4

In Comparative Example 4, a battery was produced in the same manner as in Example 1 except that the second polymer compound and the binder of the negative-electrode-side coating layer were changed to PAA as shown in Table 1, and the measurement was performed.

As shown in Table 1, in Examples 1 to 11, by making the binder contained in the positive-electrode-side coating layer of the separator the same as the first polymer compound, the cycle retention rate was able to be improved as compared with Comparative Example 1 in which the binder contained in the positive-electrode-side coating layer of the separator was different from the first polymer compound.

As shown in Table 1, in Examples 1 to 11, by making the binder contained in the negative-electrode-side coating layer of the separator the same as the second polymer compound, the cycle retention rate was able to be improved as compared with Comparative Example 2 in which the binder contained in the negative-electrode-side coating layer of the separator was different from the second polymer compound.

As shown in Table 1, in Examples 1 to 11, by using an NVA polymer as the second polymer compound, the cycle retention rate was able to be improved as compared with Comparative Examples 3 and 4 in which the second polymer compound was not an NVA polymer.

As shown in Table 1, in Examples 1 to 4, by making the mass fraction of the second polymer compound in the second layer larger than that in the first layer, the cycle retention rate was able to be further improved as compared with Example 5 in which the mass fraction of the second polymer compound in the second layer was equal to that in the first layer.

As shown in Table 1, in Examples 1 to 5 and Examples 7 to 9, by setting the mass fractions w1 and w2 of the first negative electrode active material to the negative electrode active material in the first layer and the second layer to 30% or more, the negative electrode capacity was able to be improved as compared with Example 6 in which the mass fractions w1 and w2 of the first negative electrode active material to the negative electrode active material in the first layer and the second layer were less than 30%.

The embodiment described above is intended to facilitate understanding of the present disclosure, but not intended to construe the present disclosure in any limited way. The present disclosure can be modified or improved without departing from the present disclosure, and the present disclosure includes equivalents thereof.

### DESCRIPTION OF REFERENCE SYMBOLS

1, 1A: Secondary battery
20, 20A: Battery element
21, 21A: Positive electrode lead
22, 22A: Negative electrode lead
23: Protective material
30: Exterior member
30a, 30b: Exterior sheet
31: Recess
32: Close contact member
200, 200A: Electrode body
210, 210A: Positive electrode
211, 211A: Positive electrode current collector
212, 212A: Positive electrode active material layer
220, 220A: Negative electrode
221, 221A: Negative electrode current collector
222, 222A: Negative electrode active material layer
222a: First layer
222b: Second layer
230, 230A: Separator
231: Base material
232: Positive-electrode-side coating layer
233: Negative-electrode-side coating layer

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising: a positive electrode, a negative electrode, a separator interposed between a main surface of the positive electrode and a main surface of the negative electrode, and an electrolytic solution,
wherein
the positive electrode includes a positive electrode active material layer,
the positive electrode active material layer includes a positive electrode active material and a first polymer compound,
the negative electrode includes a negative electrode active material layer,
the negative electrode active material layer includes a negative electrode active material and a second polymer compound,
the negative electrode active material includes a first negative electrode active material including silicon,
the second polymer compound contains an NVA polymer including N-vinylacetamide as a monomer,
the separator includes a base material, a positive-electrode-side coating layer on the positive electrode side of the base material, and a negative-electrode-side coating layer on the negative electrode side of the base material,
the positive-electrode-side coating layer includes the first polymer compound, and
the negative-electrode-side coating layer includes the NVA polymer.

2. The secondary battery according to claim 1, wherein the negative electrode active material layer on the separator side has a mass fraction of the NVA polymer larger than a mass fraction of the NVA polymer of the negative electrode active material layer on a side opposite to the separator.

3. The secondary battery according to claim 1, wherein
the negative electrode active material further includes a second negative electrode active material including carbon, and
the first negative electrode active material has a mass fraction to the negative electrode active material of 30% or more.
